(19) United States
(12) Patent Application Publication
(10) Pub. No.: US 2006/0118614 A1
(43) Pub. Date: Jun. 8, 2006

(54) Method for secure storing of personal data and for consulting same, chip card, terminal and server used to carry out said method

(76) Inventor: Murielle Rose, Cuers (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/468,480

(22) PCT Filed: Feb. 15, 2002
(86) PCT No.: PCT/FR02/00582

§ 371 Date: Feb. 2, 2004

(51) Int. Cl. G06K 5/00

(52) U.S. Cl. 235/380

(57) ABSTRACT

A method for the secure storing of personal data and for consulting same is carried out in a terminal that is connected to a chip card reader and fitted with a man-machine interface. A browser executing on the terminal conducts a dialogue with a remote server by way of a communication network. Pages of data are viewed on a display device of the interface. Personal data is input by a user in response to the pages displayed, and the data is stored locally for consultation and remotely on the server for saving.

The invention concerns a method for the secure storage of personal data and for consultation.

The invention also concerns chip cards intended to dialogue with a remote server through a communication network via a terminal connected to a chip card reader. It also concerns the telecommunication terminals and in particular the mobile telephones equipped with a subscriber identification chip card provided, one or the other, with a browser affording dialogue with a server.

At the present time an adult person has dozens of items of information which are personal or even confidential to him and which he may need at any time during the day.

The number of these items of information is continually increasing with the appearance of new services or new industrial products.

All this personal information includes bank account numbers, service subscription numbers, secret codes or passwords and of course telephone numbers, the volume of which is increasing simply because of the fact that it is more and more usual to add a mobile telephone number to a fixed telephone network number.

The mass of confidential information which a person has to manage today is continually increasing.

A large number of persons still use paper diaries for noting all this information, including the secret codes.

It will easily be understood that this solution is no longer at all suitable for storing confidential information and, even less, secret information.

Paper diaries may remain an advantageous solution, naturally in so far as the personal information is only telephone numbers and such information does not require frequent changes (updates).

However, for the past few years, portable electronic devices called Personal Digital Assistants (PDAs) have appeared, which make it possible to store a large amount of information, in particular personal information. These devices enable a person to create a private file in which he will be able to store all the personal information that he wishes. A password is required to activate and decipher the data stored.

Unfortunately these devices do not afford sufficient security since their operating system is an open operating system, that is to say one which is accessible and into which it is consequently possible to introduce spy programs (Trojan Horses) or viruses, even in the case where the data exchanged with the outside are enciphered.

The present invention aims to resolve this problem.

To this end, the invention proposes to enable a user to input personal data from a terminal connected to the chip card reader by means of a browser which may be present in the chip card and/or in the terminal, capable of controlling the display by the terminal of pages supplied by a server through a communication network and to demand a saving on the card of any data encrypted and input. In addition, the method makes it possible to make a copy of this back-up on the server in a way which is very simple and secure for the user. The user can thus, in the event or loss or theft of his terminal, request the server to upload his personal data onto the new equipment.

The chip cards comprising application programs developed at the present time are similar to a computer in so far as they possess an operating system and one or more application programs which can be loaded or downloaded and whose execution is initiated by the operating system. The operating system is protected by the very fact that it is stored in read only memory (ROM memory). The operating system is because of this not modifiable within the card. Amongst the application programs executed (or interpreted) by the operating system, there is provided according to the invention a browser program able to dialogue with the server and able to supply pages for entering personal data of the user.

Advantageously the data inputting is carried out on line.

The object of the present invention is therefore a method for the secure storage of personal data and for consultation, principally characterised in that it comprises the following steps:

using a terminal connected to a chip-card reader and provided with a man-machine interface comprising a display and data input means,

using a browser capable of dialoguing with a remote server through a communication network, from the said terminal,

displaying pages of data with the said display means,

inputting personal data of a user in response to the pages displayed and storing them locally for consultation and remotely on the server for saving.

According to another characteristic, the data pages are supplied by the server.

According to another characteristic, the data pages are supplied during a communication and during inputting.

The data inputting is carried out on line, the session remaining open throughout the duration of the inputting.

The personal data are recorded locally on the chip card and a copy is saved on the server.

The saving of the copy remotely is carried out substantially simultaneously with the recording locally.

The personal data are preferably encrypted by the card before being saved and can be decrypted only by the card.

The personal data are preferably encrypted by means of an enciphering algorithm using one or more keys saved in the card.

The enciphering keys are also saved by an entrusted entity.

The browser comprises the functions of a browser of the type defined by the S@T (SIM Alliance Toolbox) standard.

The pages supplied by the server are pages of the type defined by the S@TML language.

Another object of the invention is a chip card comprising a processing unit and one or more program memories comprising programs including the operating system of the card,

principally characterised in that it also comprises a browser program capable of dialoguing with a remote server through a terminal connected to a chip card reader, provided with a man-machine interface, and

in that the browser permits the entry of personal data by a user of the terminal on pages of data and their storage locally in the card for consultation and remotely on the server.

The card preferably comprises a program for protecting the saved data.

The program for protecting the data uses an encrypting algorithm utilising one or more keys stored in the card in order to encrypt the personal data entered before saving, and a decrypting algorithm for any consultation of these data by the user.

This encrypting program can be integrated in the browser program.

According to one example the card is a SIM card.

Advantageously, the browser comprises the function of a browser of the type defined by the SOT (SIM Alliance Toolbox) standard.

Another object of the invention is a communication terminal provided with a man-machine interface comprising display and inputting means able to establish communication through a network with a remote server, principally characterised in that it comprises a browser able to supply for display personal data entry pages and the storage locally of the data entered and remotely on the server.

According to one example the terminal is a mobile telephone.

In this example the said chip card is inserted in the terminal by a user and resides therein.

According to another example the terminal is of the microcomputer type and the chip card is inserted by the user at each use.

Another object of the invention is a server, principally characterised in that it comprises an application able to supply to a distant browser via a communication terminal pages which can be interpreted and/or executed by the browser, the pages comprising at least requests for the inputting of personal information, requests for the local storage of this information and requests to return this information to the server, the said application comprising a step of storing the said information received.

Other particularities and advantages of the invention will emerge clearly from a reading of the following description which is given by way of non-limiting example and with regard to the figures, in which:

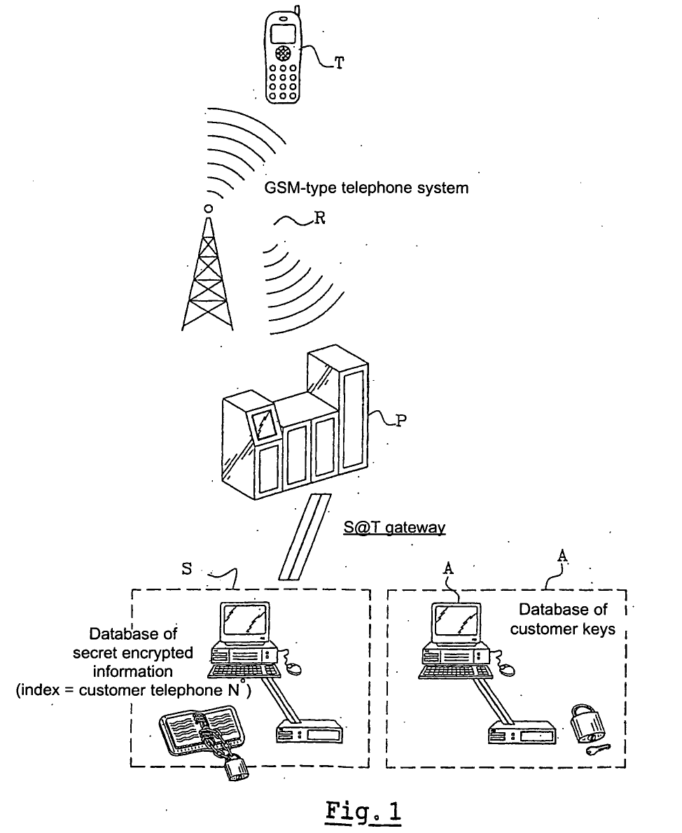

FIG. 1 illustrates the diagram of an example of a system for implementing the method according to the invention,

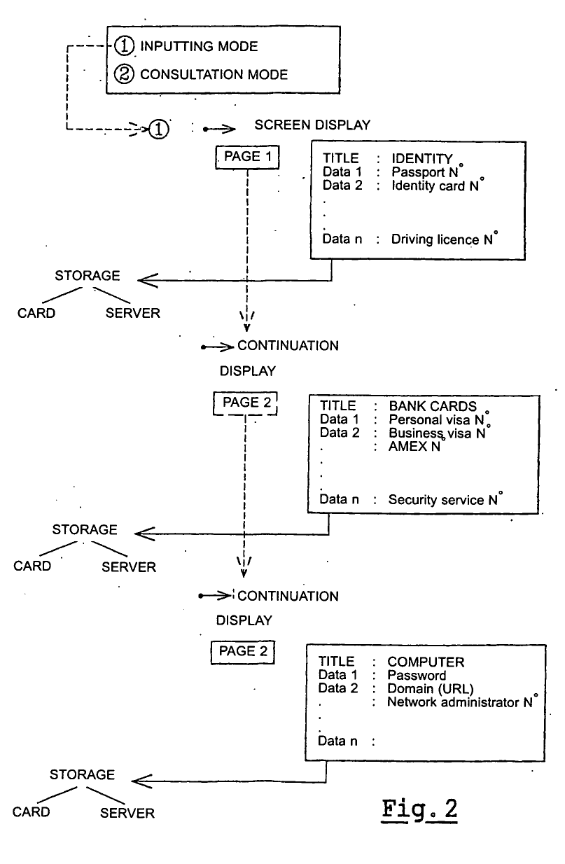

FIG. 2 illustrates an example of the inputting on several pages,

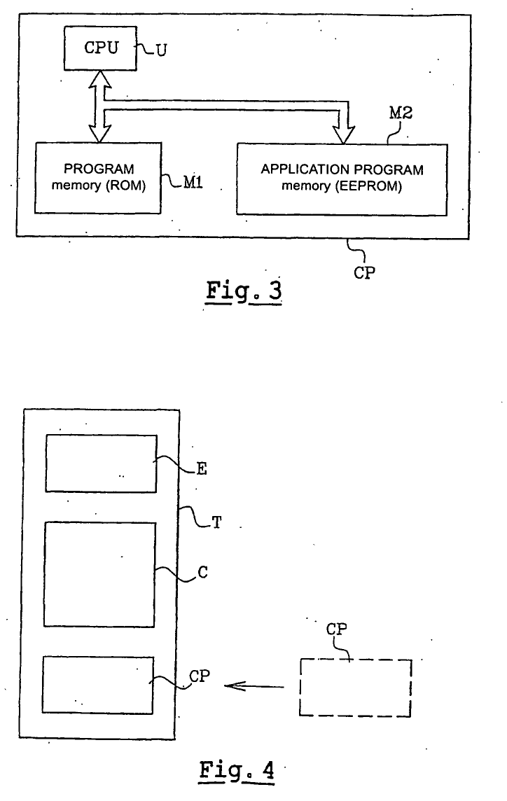

FIG. 3 illustrates a functional diagram of a chip card,

FIG. 4 illustrates a terminal provided with a chip card.

The invention applies to terminals reading chip cards or connected to a chip card reader. Hereinafter a terminal reading chip cards or connected to a chip card reader will be spoken of in general terms.

The invention therefore applies to any electronic device equipped with means of communication with a chip card. It is a case for example of mobile telephones, microcomputers, personal electronic diaries (PDAs) or banking terminals, including chip cards themselves in so far as there exist chip cards “reading” another chip card.

The chip card is either resident in the terminal or inserted in the terminal, or connected to the terminal through a reader connected to the terminal. This connection can be cabled or infrared or radio for example or of the BlueTooth type.

The chip cards which are intended to communicate with the terminal have a program for communication with the terminal. The terminal or the card comprises a browser for connecting to and exchanging with a remote server. In fact, in the present invention, the concern is with a chip card provided with a browser program, also referred to as a navigator or browser in English terminology. This browser makes it possible to dialogue via the terminal with a server through a communication network (for example GSM, UMTS or other).

The application programs are in general stored in an electrically programmable memory. These programs can thus be updated and some downloaded by means of the terminal.

An example will be described hereinafter in the case where the terminal is a telecommunication terminal such as a mobile telephone in which, it will be recalled, the chip card resides.

There is therefore next chosen, by way of example, the case of SIM cards, which are subscriber identification cards.

There is also chosen by way of example a browser as defined by the S@T standard of the SIM Alliance organisation (SIM Alliance Toolbox).

FIG. 1 gives an outline diagram in the case of this particular example.

A mobile telephone T equipped with a chip card C (SIM) can communicate through a communication network R and a gateway P with a server S dedicated to this application and in which the user is listed, for example by a customer number.

There is also shown in this FIG. 1 the entity A which represents an entrusted third party with whom the secret keys of the user customers of the server S can be stored.

Reference will now be made, for a better understanding of the invention, to the following tables given by way of example in order to illustrate the various exchanges between card, terminal and server during an inputting operation and during a consultation operation:

An inputting operation is illustrated by the steps detailed 1 to 20 in the following table.

Inputting of Personal Data:

| | | | | | Dedicated servers |
|---|---|---|---|---|---|
| | | | | Network | (supporting an application |
| | | | | (BTS, | generating the STKML pages |
| | | | | . . . , | and updating the personal |
| Step | User | Card (browser S@T) | Mobile | gateway | database at the operator) |
| 1 | Selection of | | | | |
| | data entry | | | | |
| | mode | | | | |
| 2 | | Sending of a request | | | |
| | | to server (STKML page) | | | |
| | | for loading a form or | | | |
| | | “template” to be | | | |
| | | completed | | | |
| 3 | | | Send | | |
| | | | page | | |
| 4 | | | | Send | |
| | | | | page | |
| 5 | | | | | Preparation of form |
| | | | | | Sending of page |
| | | | | | containing form |
| 6 | | | | Send | |
| | | | | page | |
| 7 | | | Receive | | |
| | | | page | | |
| 8 | | Reception of page | | | |
| | | Request mobile for | | | |
| | | display | | | |
| 9 | | | Display | | |
| | | | page | | |
| 10 | Entry of | | | | |
| | information | | | | |
| | requested on | | | | |
| | the page: | | | | |
| | personal data | | | | |
| | (name, driving | | | | |
| | licence number) | | | | |
| 11 | | Encrypting of data | | | |
| | | with encrypting | | | |
| | | algorithm (of the | | | |
| | | card or browser) and | | | |
| | | with application key | | | |
| | | stored in the card | | | |
| 12 | | Preparation of page | | | |
| | | with encrypted data | | | |
| | | for server | | | |
| 13 | | Local saving of | | | |
| | | encrypted data | | | |
| 14 | | | Send | | |
| | | | page | | |
| 15 | | | Send | | |
| | | | page | | |
| 16 | | | | Send | |
| | | | | page | |
| 17 | | | | | Storage of encrypted |
| | | | | | private data in the |
| | | | | | personal database |
| 18 | | | | | Preparation of following |
| | | | | | form Sending of page |
| | | | | | containing the form |
| 19 | | | | Send | |
| | | | | page | |
| 20 | | Etc, for all | | | |
| | | information requested | | | |

Thus, as can be seen in this example, at any time, the database of the the server S and the updating data in the card C are consistent.

In the case where the data are not stored on the server, for example through absence of coverage in the network, a recall function can be provided for automatically effecting or proposing this saving as soon as coverage on the network is detected.

The application program can also comprise functions which give choices to the user:

for saving the data both in the card and/or on the server;

only one saving can be effected either in the card or on the server or in the terminal;

the data to be stored in the terminal are preferably encrypted or may not be so according to the choice of the user.

In addition, this program can make provision for the data pages to be generated by the card or by the terminal.

The application can propose to carry out a storage at two points or not (on the SIM card, on the server, on another card, on the terminal, on a computer).

A consultation operation is illustrated by steps 1 to 9 in the following table:

Consulation of Personal Data:

| | | | | | Dedicated servers |
|---|---|---|---|---|---|
| | | | | Network | (supporting an application |
| | | | | (BTS, | generating the STKML pages |
| | | | | . . . , | and updating the personal |
| Step | User | Card (browser S@T) | Mobile | gateway | database at the operator) |
| 1 | Selection of | | | | |
| | data | | | | |
| | consultation | | | | |
| | mode | | | | |
| 2 | | Request dealt with | | | |
| | | locally (the data are | | | |
| | | stored up to date in | | | |
| | | the card) | | | |
| 3 | | Preparation of data | | | |
| | | read in the card and | | | |
| | | decrypted by means of | | | |
| | | the decrypting | | | |
| | | algorithm of the card | | | |
| | | or of the navigator | | | |
| | | and the application key | | | |
| | | stored in the card | | | |
| 4 | | Preparation of the page | | | |
| | | containing the form | | | |
| | | requested and the data | | | |
| 5 | | Request display of | | | |
| | | the page | | | |
| 6 | | | Display | | |
| | | | page | | |
| 7 | Reading of | | | | |
| | information | | | | |
| 8 | Selection of | | | | |
| | following data | | | | |
| | type to be | | | | |
| | consulted | | | | |
| 9 | | Request dealt with | | | |
| | | locally (the data are | | | |
| | | stored up to date in | | | |
| | | the card) | | | |
| | | . . . c.f. above . . . | | | |

The updating mode (data entry) preferably takes place on line and the consultation mode takes place when not connected.

Provision can also be made for the pages supplied by the server to be stored blank to enable the user to close the session and to input the data on the pages when disconnected (closed session).

Naturally the session is opened in a secure and known manner, that is to say after the user has been identified (entry of an identification code for example). In addition, in the case of a mobile telephone, the PIN code (Personal Identification Number) can also be required.

The browser provides the transmission/reception and interpretation of a page containing executable and/or interpretable commands.

Amongst the commands presented in the executable and/or interpretable pages there are:

the sending of a request to the server for the supply of an STKML page;

the request to the terminal for display of wording or data contained in the pages;

the invocation of the encrypting function or direct triggering of its execution if this function is integrated in the browser;

the local saving of the data (in particular in an electrically programmable memory of the card);

the request to send each page with the personal data entered, from the mobile for saving on the server.

The display commands can be print commands or equivalent intended for the user. The man-machine interface then comprises a display screen or a printer.

As stated above, the personal data entered and saved on the card are protected by the intrinsic security of the card (TPR hardware resisting intrusion attacks).

This security is advantageously reinforced by encrypting of these data by means of a known algorithm, using a secret key reserved for this application and contained in the card. The encrypting/decrypting algorithm can be integrated in the browser or be in the form of a separate program which can be invoked by the browser.

The data saved on the server are preferably also protected, that is to say encrypted by the card before sending. Only the card can decrypt them.

This is because the data can be stored enciphered or encrypted before saving on the server. This encrypting is carried out on the basis of a key dedicated to this application stored on the card and a duplicate of which can be stored by an entrusted third party A.

Before the display, the data are deciphered by the card.

The invention thus makes it possible to effect a saving of personal data of a user on the card and on the server.

Thus, in the event of loss or theft of the chip-card reading terminal and more precisely of the chip card, the user can recover his data and/or his key or keys in particular by requesting the loading of the saved copy of his personal data onto his new card.

FIG. 2 illustrates the example of the display of three successive pages and personal data able to be entered.

FIG. 3 illustrates the functional diagram of a chip card CP. The chip card or object with integrated circuit or equivalent comprises a central unit U connected to a non-volatile program memory M1 and at least one electrically programmable program memory M2.

The memory M1 comprises the operating system of the card CP and possibly the browser program. The chip card can thus dialogue with the remote server via the telecommunication terminal.

FIG. 4 illustrates the diagram of a terminal T. This terminal possesses the functions of chip card reader which enable it to communicate with the chip card CP. It has a screen E and a keypad C.

According to an example embodiment the terminal T is a mobile telephone, the card is a SIM card and the browser meets the S@T standard of SIM Alliance.

According to another example the terminal can be a terminal in which the chip card does not reside but must be inserted in an associated reader by a user of the terminal. It may for example be a banking terminal or a microcomputer or a PDA.

1. A method for the secure storage of personal data and for consultation, comprising the following steps:
using a terminal connected to a chip-card reader and provided with a man-machine interface comprising a display and data input means,
using a browser capable of dialoguing with a remote server through a communication network, from the said terminal,
displaying pages of data with the said display means,
inputting personal data of a user in response to the pages displayed and storing them locally for consultation and remotely on the server for saving.

2. A storage method according to claim 1, wherein the data pages are supplied by the server.

3. A storage method according to claim 1, wherein the data pages are supplied during a communication and entry.

4. A storage method according to claim 1, wherein the data entry is carried out on line.

5. A storage method according to claim 1, wherein the personal data are recorded locally on a chip card connected to said reader and a copy is saved on the server.

6. A storage method according to claim 3, wherein the saving of the copy remotely is carried out substantially simultaneously with the recording locally.

7. A storage method according to claim 1, wherein the personal data are encrypted by a card connected to said reader before being saved.

8. A storage method according to claim 7, wherein the personal data are encrypted by means of an enciphering algorithm using one or more keys saved in the card.

9. A storage method according to claim 8, wherein the enciphering key or keys are also saved by an entrusted entity.

10. A storage method according to claim 1, wherein the browser comprises the functions of a browser of the type defined by the S@T standard (SIM Alliance Toolbox).

11. A storage method according to claim 10, wherein pages supplied by the server are pages of the type defined by the S@TML language.

12. A chip card comprising a processing unit and one or more program memories comprising programs including the operating system of the card, and further including a browser program capable of dialoguing with a distant server through a terminal connected to a chip card reader, provided with a man-machine interface, and
wherein the browser permits the entry of personal data by a user of the terminal on pages of data and their storage locally in the card for consultation and remotely on the server.

13. A chip card according to claim 12, wherein said card is a SIM card.

14. A chip card according to claim 12, wherein the browser comprises the functions of a browser of the type defined by the S@T (SIM Alliance Toolbox) standard.

15. A communication terminal for implementing the method according to claim 1, said terminal being provided with a man-machine interface comprising display and inputting means able to establish communication through a network with a remote server, and including a browser able to display personal data entry pages and to store data entered both locally at the terminal and remotely on the server.

16. A terminal according to claim 15, wherein the terminal is a mobile telephone.

17. A terminal according to claim 15, wherein the terminal is of the microcomputer type, and a chip card is inserted in the terminal by a user at each use.

18. A server for implementing the method according to claim 1, comprising an application able to supply to a distant browser, via a communication terminal, pages which can be interpreted and/or executed by the browser, the pages comprising at least requests for the input of personal information and requests for the local storage of this information, requests to return this information to the server, said application executing a step of storing information received.
